(19) United States
(12) Patent Application Publication
(10) Pub. No.: US 2003/0047928 A1
(43) Pub. Date: Mar. 13, 2003

(54) Device for stabilizing a vehicle, and a vehicle provided therewith

(76) Inventor: Randall E. Gosselin, Dewinton (CA)

Correspondence Address: Ilya Zborovsky, 6 Schoolhouse Way, Dix Hills, NY, 11746, US

(21) Appl. No.: 09/947,365

(22) Filed: Sep. 7, 2001

(51) Int. Cl. B60S 9/00

(52) U.S. Cl. 280/759

(57) ABSTRACT

A device for stabilizing a vehicle has a container which is substantially closed and has a size adapted to a corresponding available compartment of a vehicle, the container having walls bounding an inner space, and a body of non-particulate material which fills the inner space of the container to provide a ballast for the vehicle and therefore to stabilize the vehicle.

### BACKGROUND OF THE INVENTION

The present invention relates to a device for stabilizing a vehicle, and a vehicle provided therewith.

It is known to stabilize a vehicle by placing on a vehicle a ballast, which usually is filled with sand. The ballast is placed in the back of the vehicle, it takes away a part of a cargo room, and sometimes breaks making a mess. Some solutions related to the devices of the above mentioned general type are disclosed in U.S. Pat. Nos. 4,902,038, 4,339,142, 4,971,356 and 5,330,227. It is believed to be advisable to improve the devices for stabilizing of vehicles of this type.

### SUMMARY OF THE INVENTION

Accordingly, it is an object of the present invention to provide a device for stabilizing a vehicle, as well as a vehicle provided with such a device, which avoids the disadvantages of the prior art.

In keeping with these objects and with others which will become apparent hereinafter, one feature of present invention resides, briefly stated, in a device for stabilizing a vehicle which has a container which is substantially closed and has a size adapted to a corresponding available compartment of a vehicle, said container having walls bounding an inner chamber; and a body of non-particulate material which fills said inner chamber of said container to provide a ballast for the vehicle and therefore to stabilize the vehicle.

It is another feature of the present invention to provide a vehicle which has a vehicle part; and a device for stabilizing said vehicle part, said stabilizing device including a container which is substantially closed and has a size adapted to a corresponding available compartment of a vehicle, said container having walls bounding an inner chamber; and a body of non-particulate material which fills said inner chamber of said container to provide a ballast for the vehicle and therefore to stabilize the vehicle.

When the device is formed and vehicle is provided with the device in accordance with the present invention, they avoid the disadvantages of the prior art.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view showing a stabilizing device in accordance with the present invention;

FIGS. 2 and 3 are a perspective view and a transverse cross-section of the inventive device in accordance with another embodiment of the present invention;

FIGS. 4 and 5 are views showing a perspective view and a cross-section of the device for stabilizing in accordance with still a further embodiment of the present invention;

FIGS. 6 and 7 are a plan view of the inventive device for stabilizing and a cross-section of one of its partitions;

FIG. 8 is a further modification of the inventive device for stabilizing; and

FIG. 9 is a view showing a vehicle provided with the inventive stabilizing device.

### DESCRIPTION OF THE PREFERRED EMBODIMENTS

A device for stabilizing a vehicle in accordance with the present invention has a container which is identified as a whole with reference numeral 1. The container 1 can be composed for example of ultraviolet stabilized low density polyethylene, or another material. It has a plurality of walls including a top wall, a bottom wall, and a plurality of peripheral walls which together bound an inner empty space 2. The stabilizing device further has a body of a non-particulate material which fills the inner space 2. The non-particulate material can be a liquid, such as for example water. In winter water will simply freeze and forms a substantially rigid body inside the container 1. In accordance with another embodiment of the present invention, the body of the particulate material can be concrete which is rigidified inside the inner space 2 of the container 1 so as also to form a substantially rigid body.

The container 1 can be composed of a transparent material, and provided with a marking line 4 which indicates a desirable filling level of the container. Thereby, a part of the inner space 2 of the container 1 remains empty and allows expansion of the non-particulate material when for example the particulate material is liquid and it is frozen and increases its volume.

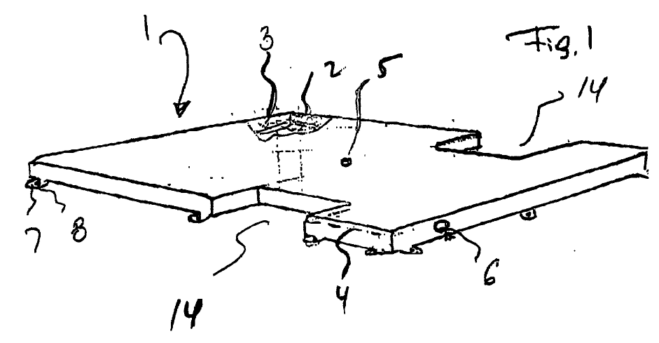

The stabilizing device described herein above, is shown in FIG. 1. It can be used for all available vehicles, such as for example automobiles, recreational vehicles, vans, trucks, etc.

As can be seen from the drawings, the container 1 is provided with a filling inlet 5, which can be formed as a throughgoing opening, a nipple, a line, etc. The container 1 is further provided with a draining outlet 6, which also can be formed as the draining opening, a nipple, a draining line, etc. The non-particulate material is supplied into the inner space 2 of the container 1 through the filling inlet 5 and can be drained from the inner space 2 through the draining outlet 6.

The container 1 is provided with means for attaching the container to a vehicle. The attaching means can be formed for example by a plurality of grommets 7 having openings 8, through which corresponding fasteners can be passed so as to fixedly connect the stabilizing device to a floor or another part of the corresponding vehicle. The grommets 7 are distributed over the periphery of the container 1.

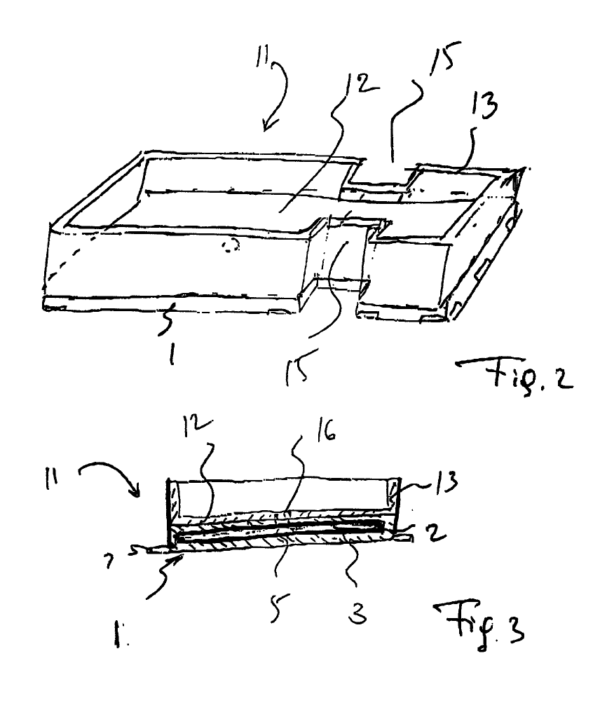

FIGS. 2 and 3 show a further embodiment of the present invention. The device for stabilizing further, has a liner which is identified as a whole with reference numeral 1. The liner is designed so as to form a false floor in a vehicle, for example the floor of a pickup box of a pickup truck, etc. The liner 11 includes a substantially horizontal part 12 which is placed on a top surface of the container 1 and a plurality of side walls 13 extending upwardly from the upwardly from the part 12. The vertical walls 13 are formed so as to extend substantially along the vertical walls of the vehicle, for example of the pickup box of a pickup truck. The liner 1 composed of the substantially horizontal part 12 and the substantially vertical walls 13 can be formed as a one-piece element. It can be composed of high or low density polyethylene or polypropolyne. The liner can be fixedly attached to the container 1, for example by glueing, welding, etc.

As can be seen from FIG. 1, the container 1 is provided with a recess means for accommodating corresponding projecting parts of a vehicle. In particular, in FIG. 1 the recess means are formed as two recesses 14 provided at opposite sides of the container 1 for receiving a wheel well parts of the vehicle. As can be seen from FIG. 2, the liner 11 has similar recess 15 substantially corresponding to the recesses 14. As can be seen from FIG. 3, the liner 11 has a fillng inlet 16 substantially corresponding to the filling inlet 5 of the container 1, for filling the non-particulate material into the inner space 2 of the container 1.

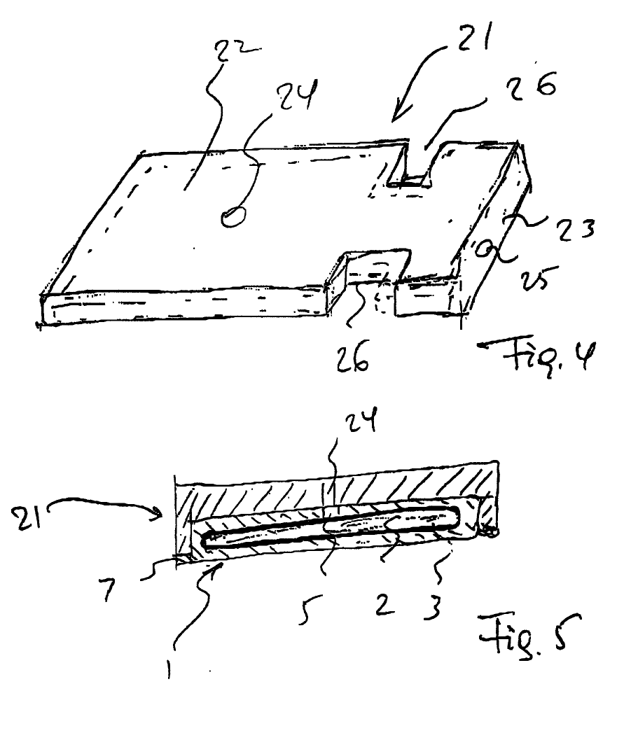

In accordance with the embodiment of the present invention shown in FIGS. 4 and 5, the device for stabilizing further has a substantially hard cover element which is identified with reference numeral 21. The cover element 21 has a substantially horizontal part 22 and a plurality of peripheral walls 23 defining an inner space therebetween, substantially corresponding to the dimensions of the container 1. The cover element 21 can be composed of ultraviolet stabilized high density polyethylene, or another material. The peripheral walls 23 extend downwardly from the substantially horizontal part 22. The cover element 21 is provided with filling inlet means 24 and draining outlet means 25, substantially corresponding to the filling inlet means 5 and the draining outlet means 6 of the container 1, for filling and draining of the non-particulate material. The cover element 21 snugly embraces the container 1. Its substantially horizontal part 22 forms a false floor of a vehicle. The cover element 21 also has cavities 26 substantially corresponding to the cavities 14 of the container 11 for receiving corresponding projections of the vehicle.

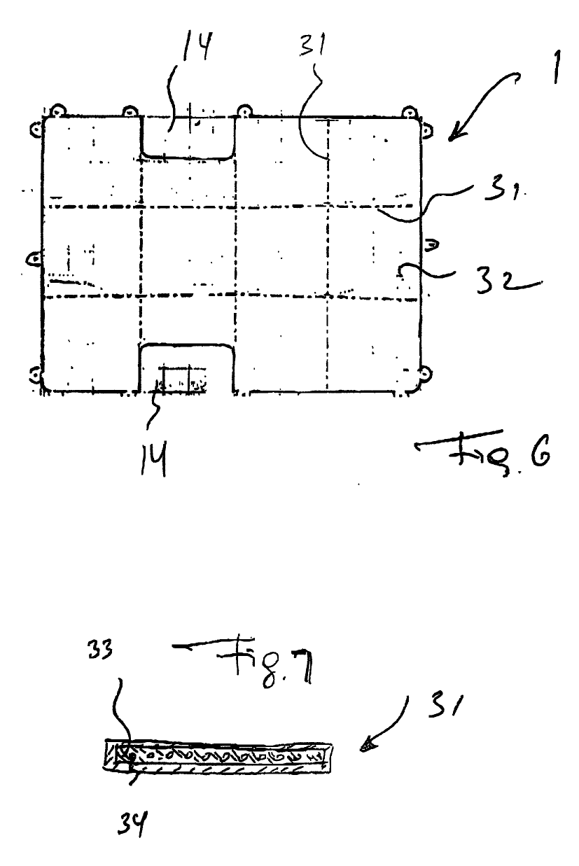

FIGS. 6 and 7 show another embodiment of the present invention. Here the device of stabilizing is provided with a plurality of partitions which are identified with reference numeral 31. The partitions 31 subdivide the inner space 2 of the container 1 into a plurality of compartments 32. The partitions 31 can be formed as transverse walls 33 each provided with a plurality of openings 34. The non-particulate material, for example a liquid can pass through the openings 34 from one compartment 32 to the other, so as not to accumulate in one area of the container 1, but instead to be uniformly distributed over the whole inner space of the container. The walls 33 of the partitions 31 can be composed of a same material as the material of the container 1. Also, the walls 31 can be made of one-piece with the container 1.

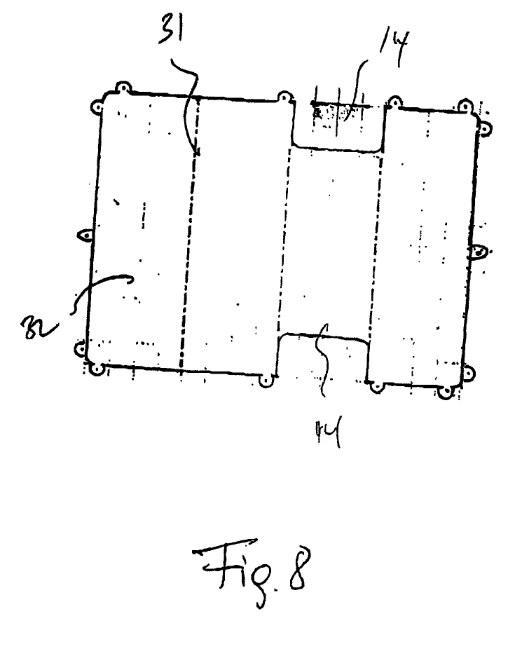

FIG. 6 shows the container 1 which is formed for a long box pick-up, and in the container 1 the recesses 14 are displaced to the front or left side of the container. The container 1 shown in FIG. 8 is designed for a long box truck, or a vehicle with a different location of the wheel well parts. In particular here the recesses 14 are offset toward the rear or the right side of the container 1. Also, the partitions 31 in FIG. 6 extend a mutually perpendicular directions, while the partitions 31 in FIG. 8 extend only in a transverse direction.

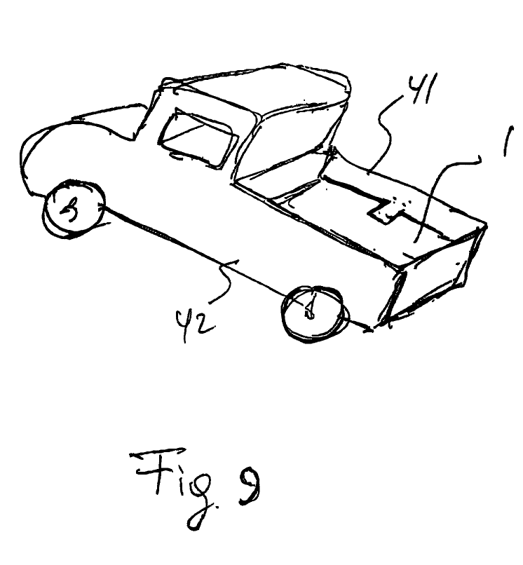

As can be seen from FIG. 9, the container 1 of the inventive device for stabilizing is placed in a simple manner, for example in a pick-up box 41 of a pickup-truck 42. In the same fashion, the container 1 of the device for stabilizing in accordance with the present invention, with or without the liner 11 and/or the cover element 21, can be placed in any other vehicle.

It will be understood that each of the elements described above, or two or more together, may also find a useful application in other types of constructions differing from the types described above.

While the invention has been illustrated and described as embodied in device for stabilizing a vehicle, and a vehicle provided therewith, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for stabilizing a vehicle, comprising a container which is substantially closed and has a size adapted to a corresponding available compartment of a vehicle, said container having walls bounding an inner space; and a body of non-particulate material which fills said inner space of said container to provide a ballast for the vehicle and therefore to stabilize the vehicle.

2. A device as defined in claim 1, wherein said body of non-particulate material is a body of liquid.

3. A device as defined in claim 1, wherein said body of non-particulate material is a body of a frozen liquid.

4. A device as defined in claim 1, wherein said body of non-particulate material is a body of concrete.

5. A device as defined in claim 1, wherein said container has side recess means for receiving corresponding protrusions of the vehicle.

6. A device as defined in claim 1, wherein said container has means for attaching the container to a part of the vehicle.

7. A device as defined in claim 6, wherein said attaching means include a plurality of grommets distributed over said container.

8. A device as defined in claim 1, wherein said container has a plurality of partitions subdividing said inner space into a plurality of individual compartments, said partitions being permeable for the non-particulate material of said body of non-particulate material.

9. A device as defined in claim 1, wherein said container is transparent, said container being provided with marking means for marking a degree of filling of said inner space.

10. A device as defined in claim I, wherein said container has a filling inlet for filling the non-particulate material into an inner space of said container.

11. A device as defined in claim 1, wherein said container has a draining outlet for draining non particulate material from said inner space of said container.

12. A device as defined in claim 1; and further comprising an a lining element arranged on said container and adapted to produce a false floor for a vehicle.

13. A device as defined in claim 12, wherein said lining element has substantially horizontal portion arranged on said container and a plurality of substantially vertical walls extending from said horizontal portion.

14. A device as defined in claim 12, wherein said lining element has filling inlet means.

15. A device as defined in claim 1; and further comprising a substantially hard cover element arranged substantially snugly over said container.

16. A device as defined in claim 15, wherein said cover element has a substantially horizontal part and a plurality of peripheral walls extending downwardly from said substantially horizontal part.

17. A device as defined in claim 15, wherein said cover element has means selected from the group consisting of non-particulate material filling inlet means, filling outlet means, and both.

18. A vehicle, comprising a vehicle part; and a device for stabilizing said vehicle part, said stabilizing device including a container which is substantially closed and has a size adapted to a corresponding available compartment of a vehicle, said container having walls bounding an inner space; and a body of non-particulate material which fills said inner space of said container to provide a ballast for the vehicle and therefore to stabilize the vehicle.

19. A method of stabilizing a vehicle, comprising the steps of providing a vehicle part; and arranging in the vehicle part a device for stabilizing which includes a container which is substantially closed and has a size adapted to a corresponding available compartment of a vehicle, said container having walls bounding an inner space; and a body of non-particulate material which fills said inner space of said container to provide a ballast for the vehicle and therefore to stabilize the vehicle.
